(19) United States
(12) Patent Application Publication
(10) Pub. No.: US 2013/0025073 A1
(43) Pub. Date: Jan. 31, 2013

(54) DETERGENT COMPOSITIONS

(71) Applicants: Philip Frank SOUTER, Northumberland (GB); Michelle Jackson, Tyne & Wear (GB); David John Tarbit, Tyne & Wear (GB); Jean-Pol Boutique, Gambloux (BE)

(72) Inventors: Philip Frank SOUTER, Northumberland (GB); Michelle Jackson, Tyne & Wear (GB); David John Tarbit, Tyne & Wear (GB); Jean-Pol Boutique, Gambloux (BE)

(21) Appl. No.: 13/557,259

(22) Filed: Jul. 25, 2012

(30) Foreign Application Priority Data
Jul. 25, 2011 (EP) 11175270.5
Jul. 12, 2012 (EP) 12176098.7

(51) Int. Cl. C11D 3/60; D06L 1/16

(52) U.S. Cl. 8/137; 510/393

(57) ABSTRACT

The present invention relates to cleaning compositions comprising protease-sensitive components, anionic surfactant and protease enzyme, and also incorporating a reversible stabilizer for the protease enzyme and methods for making such compositions.

### FIELD OF THE INVENTION

This invention relates to liquid compositions comprising enzymes and anionic surfactants, and methods of making them.

### BACKGROUND OF THE INVENTION

It is well known to incorporate anionic surfactants into detergent compositions, in particular laundry or dish-washing detergent compositions. Recent trends have aimed for lower volume, concentrated liquid products. Such concentrated products reduce the need for large volumes which are inefficient for shipment and storage. However, manufacture of more highly concentrated products is challenging for the formulator as the chemistry is more aggressive for sensitive components and stability problems can arise.

Storage stability in enzyme-containing detergents is already recognized as a problem, even without the increased demands of high concentration, particularly in the presence of enzymes and in particular if the enzyme is protease. The prior art has dealt extensively with improving storage stability by incorporating stabilizing solvents, inorganic salts and/or protease stabilizers. For example, U.S. Pat. No. 4,566,985 discloses benzamidine hydrohalide to inhibit protease, U.S. Pat. No. 5,972,873 discloses para-substituted phenyl boronic acids as highly effective stabilizers, and EP376705 describes lower aliphatic alcohol and a salt of a lower carboxylic acid and a predominantly nonionic surfactant system, EP381262 describes a stabilizing system comprising a boron compound and a polyol which are capable of reacting, WO92/19707 describes meta substituted boronic acids as reversible stabilizers, U.S. Pat. No. 4,537,707 describes stabilization using a combination of boric acid and formate and U.S. Pat. No. 5,431,842 describes ortho-substituted phenyl boronic acids as stabilizers.

It would be desirable to increase the stability of such concentrated liquid compositions, in particular for enzyme-containing compositions and in particular in detergent compositions comprising amine-neutralised anionic surfactant, which have proved especially difficult to stabilize. Without wishing to be bound by theory the present inventors believe that interactions occur between the amine-neutralised anionic surfactant and the stabilizer reducing the efficacy of many stabilisers. The present invention provides a means of alleviating these problems.

### SUMMARY OF THE INVENTION

In accordance with the present invention there is provided a liquid detergent composition comprising: (i) amine-neutralised anionic surfactant; (ii) a serine protease enzyme, (iii) protease sensitive-component, and (iv) phenyl boronic acid or phenyl boronic acid derivative free of reactive aldehyde substituents; and (v) an adjunct ingredient selected from (a) additional enzyme stabilizers selected from the group consisting of calcium formate or calcium chloride, 1,2 propanediol, diethylene glycol, lactic acid and derivatives thereof, (b) chelating agent, (c) structurant or mixtures thereof. The preferred adjunct ingredient for (v) is selected from the group consisting of calcium chloride, calcium formate, lactic acid and/or diethylene glycol, most preferably calcium chloride, calcium formate and/or diethylene glycol.

The present invention also provides a method for making a liquid detergent composition according to any preceding claim comprising the following steps:
(i) reacting an acid precursor of an anionic surfactant with an amine to produce a neutralized anionic surfactant;
(ii) mixing the neutralized anionic surfactant with a protease enzyme;
(iii) mixing the neutralized anionic surfactant with a protease-sensitive component; and
(iv) mixing the amine-neutralised surfactant with phenyl boronic acid or phenyl boronic acid derivative free of reactive aldehyde substituents,
(v) mixing the amine-neutralised surfactant with an adjunct ingredient selected from (a) additional enzyme stabilizers selected from the group consisting of calcium formate or calcium chloride, 1,2 propanediol, diethylene glycol, lactic acid and derivatives thereof, (b) chelating agent, (c) structurant or mixtures thereof, preferably selected from calcium chloride, calcium formate and/or diethylene glycol;

wherein steps (ii), (iii), (iv) and (v) may be simultaneous or sequential in any order with the proviso that step (iv) must be simultaneous with or prior to at least one of steps (ii) or (iii). Preferably the neutralized anionic surfactant is mixed with a detergent adjunct prior to addition of the protease.

The invention also provides a method of treating and/or cleaning a surface, preferably a textile, comprising (i) forming an aqueous wash liquor comprising water and a composition textile, comprising (i) forming an aqueous wash liquor comprising water and a composition according to the present invention, (ii) treating the surface with the aqueous wash liquor preferably at a temperature of 40° C. or less, or more preferably at a temperature of 30° C. or less, most preferably at a temperature of 20° C. or less; and (iii) rinsing the surface.

### DETAILED DESCRIPTION OF THE INVENTION

### Liquid Detergent Compositions

As used herein, liquid detergent compositions refers to any treatment composition comprising a liquid capable of wetting and cleaning fabric or hard surfaces e.g., clothing either in a hand wash or in a domestic washing machine, or for dishwashing, typically being referred to as liquids or gels, optionally provided in unit dose, such as pouch or pod form. The composition can include solids or gases in suitably subdivided form. Preferred liquid compositions have densities in the range from 0.9 to 1.3 g/cm³ more preferably from 1 to 1.1 g/cm³, excluding any solid additives but including any bubbles, if present. Examples of liquid detergent compositions include heavy-duty liquid laundry detergents for use in the wash cycle of automatic washing-machines, liquid finewash and liquid colour care detergents such as those suitable for washing delicate garments, e.g., those made of silk or wool, either by hand or in the wash cycle of automatic washing-machines, or hard surface cleaners such as dish-washing detergents either for hand or machine-washing, preferably for use in automatic washing machines. The corresponding compositions having flowable yet stiffer consistency, known as gels or pastes, are likewise encompassed. The rheology of shear-thinning gels is described in more detail in the literature, see for example WO04027010A1 Unilever.

In general, the liquid detergent compositions herein may be isotropic or non-isotropic. However, for some specific embodiments, they do not generally split into separate layers such as phase split detergents described in the art. One illustrative composition is non-isotropic and on storage is either (i) free from splitting into two layers or, (ii) if the composition splits into layers, a single major layer is present and comprises at least about 80% by weight, more specifically more than about 90%, even more specifically more than about 95% of the composition. Other illustrative compositions are isotropic. Preferably the compositions of the invention are free from splitting into two or more layers, and are substantially homogeneous.

As used herein, when a composition and/or method of the present invention is “substantially free” of a specific ingredient(s) it is meant that specifically none, or in any event no functionally useful amount, of the specific ingredient(s) is purposefully added to the composition. It is understood to one of ordinary skill in the art that trace amounts of various ingredient(s) may be present as impurities. For avoidance of doubt otherwise, “substantially free” shall be taken to mean that the composition contains less than about 0.1%, specifically less than 0.01%, by weight of the composition, of an indicated ingredient.

In one embodiment, the liquid detergent compositions thin on dilution, possess specified high-shear undiluted and diluted viscosities, and specifically are shear thinning having specified low-shear and high-shear neat product viscosities.

The liquid detergent compositions of the invention preferably relate to products for and/or methods relating to and/or use of the claimed compositions that are for air care, car care, dishwashing, fabric conditioning (including softening), laundry detergency, laundry and rinse additive and/or care, hard surface cleaning and/or treatment, and other cleaning for consumer or institutional use. According to the invention, the composition may typically be a component in a cleaning composition, such as a detergent composition, e.g., a laundry detergent composition or a dishwashing detergent composition. Especially preferred is a liquid laundry detergent composition.

### Amine-Neutralised Anionic Surfactant

### Anionic Surfactants

As used herein, the term “amine neutralised anionic surfactant” is based on an anionic surfactant other than soap.

The compositions and methods of the present invention contain an amine-neutralised anionic surfactant as an essential component, optionally in addition to additional other surfactants. Mixtures of two or more surfactants, including two or more anionic surfactants, or mixtures thereof with nonionic surfactants can be used. Preferred anionic surfactants include linear or branched anionic surfactants, preferably linear alkylbenzenesulfonate (LAS), alpha-olefinsulfonate, alkyl sulfate (fatty alcohol sulfate), alcohol ethoxysulfate (AES (sometimes termed SLES)), secondary alkanesulfonate, alpha-sulfo fatty acid methyl ester, alkyl- or alkenylsuccinic acid, and mixtures thereof, having an amine counterion.

Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alky sulfates, alkyl alkoxysulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

The amine-neutralised anionic surfactants have an amine counterion. Mixtures of cations are also possible, however at least a portion, preferably at least 10 or 20 or even at least 50 or preferably at least 70, 80 or 90 or at least 95 wt % or even all of the anionic surfactant must have an amine counterion. Illustrative examples of suitable cations for the anionic surfactants include ammonium, substituted ammonium, or preferably amino functional cations, most preferably such as alkanolamine groups and the like and mixtures thereof. In a preferred embodiment, the anionic surfactant comprises a cation selected from alkanolfunctionalised amine cations. Ethanolamines are preferred such as monoethanolamine, diethanolamine or triethanolamine, preferably comprising monoethanolamine. Additional information on suitable neutralizers may be found herein. In a preferred embodiment the anionic surfactants are substantially linear.

In order to prepare the amine-neutralised anionic surfactant, the anionic surfactant is preferably contacted in its acid form with a neutraliser selected from amines.

The anionic surfactant is preferably present in the composition in an amount of from 0.01% to 70%, preferably from 5 wt % more specifically from 10% to 60%, even more specifically from 15% to 50%, by weight of the detergent composition.

Protease Enzyme

Suitable proteases for use in the invention include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, U.S. Pat. No. 7,262,042, WO09/021,867 and WO11/072,117.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, including those derived from Bacillus amyloliquefaciens described in WO 07/044,993A2.

Preferred proteases include those derived from Bacillus gibsonii, Bacillus amyloliquefaciens or Bacillus Lentus.

In a preferred aspect, the proteases are the cold water proteases described in WO 11/072,117, particularly wherein the protease is a variant of a parent protease, said parent protease being subtilisin BPN' wild-type, comprising a total of three, four, five, six, seven, eight, nine, 10, 11, 12, 13, 14 or 15 mutations selected from groups (a) and (b) below, wherein preferably at least one mutation is selected from group (a):
(a) A1E/T, S9/T, P14L, A15L, L16C, H17T, S18L/T, Q19K, G20A, Y21N/T, T22L, G23E, S33T, K43Y, N76D, G102A, N109A/S/G, A137V, K141R, T158S, G169A, S204E, P210S, N218S, N243P/V, S248N/A, S249A, K256R, L257G, S260P, and N269D; and
(b) S24G/R/E, N25G, P40A/E, P52L, S53G, T55P, F58G, Q59S, N61E/P/G/S, N62Q/R/S, S63G/H, V68A, S78N, P86S, S87D/G, A88T/V, S89Y, A92G, L96T, G97A, G100N/Q/T, S101N, Q103E/H, Y104N, W106F, I111V, A114G, I115V, A116N/T, N117S, N118G, N123A/G/Q/V, M1241/V, S125A, L126A, G128A/S, P129E/Q/S/V, S130G, G131S/H, S132N, A133V, A134T, A144K, S145D, S159K, S161P, S162G/K, Y167A, P194L, V203Y, Q206D/E, K213L, Y217Q/L/D, V227T, A232T, P239R/V, N240K, T242R, K265N, L267V, and Q275E.

In a further aspect, above variant of subtilisin BPN' wild-type has a total net charge of −1, 0 or +1 relative to the BPN' wild-type.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao. Further suitable proteases are described in WO2011/03623, WO2011/140316, WO2011/140364 and WO2012/05778.

Protease-Sensitive Component

The protease-sensitive component may be any component in the detergent composition which interacts with protease enzyme to lose its desired activity in the wash. Examples include perfume-esters and protein-based components, preferably comprising enzymes. In particular, the protease-sensitive component may be selected from further enzyme selected from the group consisting of hemicellulases, peroxidases, cellulases, cellobiose dehydrogenases, xyloglucanases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, lichenases glucanases, arabinosidases, hyaluronidase, chondroitinase, laccase, protease, particularly non-serine protease, amylases, or mixtures thereof, preferably selected from amylase, lipase and cellulase enzymes. Suitable enzymes include additional protease, lipase, peroxidase, amylolytic enzyme, e.g., alpha-amylase, glucoamylase, maltogenic amylase, CGTase and/or a cellulase, mannanase (such as MANNAWAY™ from Novozymes, Denmark), pectinase, pectate lyase, cutinase, and/or laccase.

In general the properties of the chosen enzyme(s) should be compatible with the selected detergent, (i.e., pH-optimum, compatibility with other enzymatic and non-enzymatic ingredients, etc.), and the enzyme(s) should be present in effective amounts.

Lipases: Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al. (1993), Biochemica et Biophysica Acta, 1131, 253-360), B. stearothermophilus (JP 64/744992) or B. pumilus (WO 91/16422).

The lipase may be a “first cycle/wash lipase” such as those described in U.S. Pat. No. 6,939,702 B1 and US PA 2009/0217464. In one aspect, the lipase is a first-wash lipase, preferably a variant of the wild-type lipase, shown as SEQ ID NO:3 from Thermomyces lanuginosus comprising T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Preferred lipases would include those sold under the tradenames Lipex®, Lipolex® and Lipoclean®.

Amylase: Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) the variants described in U.S. Pat. No. 5,856,164 and WO99/23211, WO 96/23873, WO00/60060 and WO 06/002643, especially the variants with one or more substitutions in the following positions versus the AA560 enzyme shown as SEQ ID NO:7:

26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.

(c) variants exhibiting at least 90% identity with SEQ ID NO:6, especially variants with deletions in the 183 and 184 positions and variants described in WO 00/60060, which is incorporated herein by reference.

(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). In one aspect, suitable amylases include NATALASE®, STAINZYME®, TERMAMYL ULTRA® and STAINZYME PLUS® and mixtures thereof.

Cellulases: In one aspect, other enzymes include cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and U.S. Pat. No. 5,691,178. Suitable cellulases include the alkaline or neutral cellulases having colour care benefits. Examples of such cellulases are cellulases described in U.S. Pat. No. 5,520,838, U.S. Pat. No. 5,948,672, U.S. Pat. No. 5,919,691, U.S. Pat. No. 6,001,639, WO 98/08940. Other examples are cellulase variants such as those described in U.S. Pat. No. 6,114,296, U.S. Pat. No. 5,457,046, U.S. Pat. No. 5,457,046, U.S. Pat. No. 5,686,593, U.S. Pat. No. 5,763,254, U.S. Pat. No. 6,117,664, US PA 2009/0170747A1 and PCT/DK98/00299. Commercially available cellulases include CELLUZYME®, and CAREZYME® (Novozymes A/S), CLAZINASE®, and PURADAX HA® (Genencor International Inc.), and KAC-500(B)® (Kao Corporation).

In one aspect, the cellulase may be a bacterial cleaning cellulase. Such bacterial cleaning cellulases are endo beta 1,4-glucanases and have a structure which does not comprise a class A Carbohydrate Binding Module (CBM). A class A CBM is defined according to A. B. Boraston et al. Biochemical Journal 2004, Volume 382 (part 3) pages 769-781. In particular, the cellulase does not comprise a class A CBM from families 1, 2a, 3, 5 and 10.

In one aspect, the bacterial cleaning cellulase may be a glycosyl hydrolase having enzymatic activity towards amorphous cellulose substrates, wherein the glycosyl hydrolase is selected from GH families 5, 7, 12, 16, 44 or 74. In one aspect, the cellulase may be a glycosyl hydrolase selected from GH family 5. In one aspect, the cellulase may be Celluclean®, supplied by Novozymes. This cellulase is described in more detail in U.S. Pat. No. 7,141,403. The glycosyl hydrolase (GH) family definition is described in more detail in Biochem J. 1991, v280, 309-316.

Another suitable bacterial cleaning cellulase is a glycosyl hydrolase having enzymatic activity towards both xyloglucan and amorphous cellulose substrates, wherein the glycosyl hydrolase is selected from GH families 5, 12, 44 or 74. The glycosyl hydrolase enzyme may belong to glycosyl hydrolase family 44.

Suitable glycosyl hydrolases may be selected from the group consisting of: GH family 44 glycosyl hydrolases from Paenibacillus polyxyma (wild-type) such as XYG1006 described in U.S. Pat. No. 7,361,736 or are variants thereof; GH family 12 glycosyl hydrolases from Bacillus licheniformis (wild-type) such as Seq. No. ID: 1 described in U.S. Pat. No. 6,268,197 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID NO. 2 of U.S. Pat. No. 7,172,891, or variants thereof.

Suitable glycosyl hydrolases may be selected from the group consisting of: GH family 44 glycosyl hydrolases from Paenibacillus polyxyma (wild-type) such as XYG1006, shown as SEQ ID NO:4 or are variants thereof.

Suitable bacterial cleaning cellulases are sold under the tradenames Celluclean® and Whitezyme® (Novozymes A/S, Bagsvaerd, Denmark).

In one aspect, the composition may comprise a fungal cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Peroxidases/Oxidases: Suitable peroxidases/oxidases include those of plant, bac-terial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME® (Novozymes A/S).

Other enzymes: Other preferred enzymes include pectate lyases preferably those that are variants of SEQ ID NO:5 and those sold under the tradenames Pectawash®, Xpect®, Pectaway® and the mannanases sold under the tradenames Mannaway® (all from Novozymes A/S, Bagsvaerd, Denmark), and Purabrite® (Genencor International Inc., Palo Alto, Calif.).

The composition may comprise benefit agent delivery particles. In one aspect, the benefit agent delivery particles comprise an encapsulate comprising at least one cellulosic polymer selected from the group consisting of hydroxypropyl methylcellulose phthalate (HPMCP), cellulose acetate phthalate (CAP), and mixtures thereof, and a benefit agent. Such polymers include polymers that are commercially available under the trade names NF Hypromellose Phthalate (HPMCP) (Shin-Etsu), cellulose ester NF or cellulose cellacefate NF (CAP) from G.M. Chemie Pvt Ltd, Mumbai, 400705, India and Eastman Chemical Company, Kingsport, USA. The benefit agent may comprise a material selected from the group consisting of enzymes, hueing dyes, metal catalysts, bleach catalysts, peracids, perfumes, biopolymers, and mixtures thereof. The benefit provided by the benefit agent delivery particle may include whiteness and/or dingy cleaning, stain removal (such as grass, blood, or gravy), greasy stain removal, bleaching, longer lasting freshness, and fabric hueing.

In a preferred aspect the benefit agent comprises an enzyme, preferably selected from the group consisting of hemicellulases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, B-glucanases, arabinosidases, hyaluronidase, chondroitinase, laccase, oxidoreductases, dehydrogenases, xyloglucanases, amylases, cellulases, and mixtures thereof.

The enzyme(s) may be included in the detergent composition by adding separate additives containing one or more enzymes, or by adding a combined additive comprising all of these enzymes. A detergent additive of the invention, i.e., a separate additive or a combined additive, can be formulated, e.g., granulate, a liquid, a slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonyl-phenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

It is at present contemplated that in the detergent compositions the enzyme(s) may be added in an amount corresponding to 0.001-100 mg of enzyme protein per liter of wash liquor, preferably 0.005-5 mg of enzyme protein per liter of wash liquor, more preferably 0.01-1 mg of enzyme protein per liter of wash liquor and in particular 0.1-1 mg of enzyme protein per liter of wash liquor. However, the compositions of the present invention comprise at least 0.0001 to about 0.1% weight percent of pure enzyme protein, such as from about 0.0001% to about 0.01%, from about 0.001% to about 0.01% or from about 0.001% to about 0.01%. However, when using a formulated enzyme the detergent composition comprises from about 0.02% to about 20% weight percent, such as or from about 0.05% to about 15% weight, or from about 0.05 to about 20%, or from about 0.05% to about 5%, or from about 0.05% to about 3%.

Phenyl Boronic Acid or Derivatives Thereof Free of Reactive Aldehyde Substituents

The phenyl boronic acid is most preferably unsubstituted, however, phenyl boronic acid derivatives which are substituted but free of reactive aldehyde substituents are also suitable for use in the present invention.

Water Content

The detergent compositions according to the present invention also contain water. The amount of the water present in the compositions is suitably from about 0.001 wt % or from 0.5 wt % or even from 1 wt % to about 60 wt %, or more preferably is relatively low relative to traditional liquid laundry detergent compositions, specifically the water content may be from about 5% to about 25%, by weight of the cleaning composition. When highly concentrated liquids or gels are intended according to the invention, the water content may comprise less than 20%, preferably less than 15%, more preferably less than 12%, most preferably less than 8% by weight of water. For instance, containing no additional water beyond what is entrained with other constituent ingredients. The term liquid also includes viscous forms such as gels and pastes. The non-aqueous liquid may include other solids or gases in suitably subdivided form, but excludes forms which are non-liquid overall, such as tablets or granules.

In one embodiment, the water to be used is selected from distilled, deionized, filtered, reverse osmosis treated, and combinations thereof. In another optional embodiment of the water may be any potable water, e.g., as received from a city water treatment works.

Cleaning Adjuncts

Such cleaning compositions generally comprise an additional cleaning adjunct, preferably comprising a mixture of components. Typically the cleaning adjunct will be present in the composition in an amount from 0.001 to 99.9 wt %, more typically from 0.01 to 80 wt % cleaning adjunct. Suitable cleaning/detergent adjuncts comprise: additional surfactants, builders, bleaches, bleach systems, bleach catalysts, chelants, colorants, bleach boosters such as imine bleach boosters, dye transfer agents, deposition aids, dispersants, additional enzymes, and enzyme stabilizers, catalytic materials, bleach activators, hydrogen peroxide, sources of hydrogen peroxide such as percarbonate and/or perborate, especially percarbonate coated with material such as carbonate and/or sulphate salt, silicate salt, borosilicate, and any mixture thereof; pre-formed peracid, including pre-formed peracid in encapsulated form; transition metal catalysts; suds suppressors or suppressor systems such as silicone based suds suppressors and/or fatty acid based suds suppressors; fabric-softeners such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; carboxylate polymers such as maleic acid polymers or co-polymers of maleic and acrylic acid; perfumes such as perfume microcapsules, starch encapsulated accords, perfume spray-on; soap rings; aesthetic particles; dyes; fillers such as sodium sulphate, although it is preferred for the composition to be substantially free of fillers; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; solvents such as 1,2 propanediol, monoethanolamine; diethylene glycol, ethanol, and any mixture thereof; hydrotropes such as sodium cumene sulphonate, sodium xylene sulphonate, sodium toluene sulphonate, and any mixtures; organic acids such as citric acid; and any combination thereof, optical brighteners, photoactivators, fluorescers, fabric hueing agents, including dyes and pigments, polymeric dispersing agents, clay soil removal agents, filler salts, hydrotropes, structure elasticizing agents, hydrolyzable surfactants, preservatives, anti-oxidants, anti-shrinkage agents, germicides, fungicides, anti-tarnish, anti-corrosion agents, alkalinity sources, solubilizing agents, carriers, processing aids, pigments, non-fabric substantive dyes, perfumes and other odour-control agents, fabric care benefit agents, cleaning polymers and pH control agents. Some of these optional cleaning adjunct ingredients are described in more detail below.

In a preferred aspect in addition to the amine-neutralized anionic surfactant the composition comprises one or mixtures of more than one additional surfactant, which additional surfactant may be selected from non-ionic including semi-polar and/or anionic and/or cationic and/or zwitterionic and/or ampholytic and/or semi-polar nonionic and/or mixtures thereof.

The compositions of the invention may comprise optional additional other surfactants such as nonionic, cationic, zwitterionic, amphoteric or soap or mixtures thereof.

The surfactant comprises at least about 10%, specifically from more than 10% to about 75%, more specifically from about 20% to about 70%, even more specifically from about 40% to about 60%, by weight of the liquid laundry detergent compositions.

In one embodiment, the surfactants are substantially linear.

In another embodiment, the compact liquid laundry detergent composition is internally structured by a surfactant, and the liquid laundry detergent has the physical form of a flowable liquid, gel or paste.

In one embodiment, the surfactant comprises less than about 5%, specifically from about 0% to less than about 5%, by weight of the composition, more specifically substantially free of amine oxide and/or amphoteric surfactant, such as C8-C18 betaine.

Illustrative examples of surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, in U.S. Pat. No. 4,239,659, Murphy, issued Dec. 16, 1980, U.S. Pat. No. 4,285,841, Barrat et al, issued Aug. 25, 1981, U.S. Pat. No. 4,284,532, Leikhim et al, issued Aug. 18, 1981, U.S. Pat. No. 4,285,841, U.S. Pat. No. 3,919,678 and in U.S. Pat. Nos. 2,220,099 and 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch). See also Surfactant Science Series, Volumes 67 and 129, published by Marcel Dekker, NY, pertaining to liquid detergents and therein especially the chapters pertaining to heavy-duty liquid laundry detergents.

### Nonionic Surfactant

In one embodiment, the compositions and methods of the present invention may contain a nonionic surfactant or a mixture of surfactants wherein a nonionic surfactant is an optional component. Mixtures of two or more nonionic surfactants, can be used. Suitable non-ionic surfactants are such as alcohol ethoxylate, nonyl-phenol ethoxylate, alkylpolyglycoside, alkyldimethylamine-oxide, ethoxylated fatty acid monoethanol-amide, fatty acid monoethanolamide, polyhydroxy alkyl fatty acid amide, or N-acyl N-alkyl derivatives of glucosamine (“glucamides”).

Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp.), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof. Additional, illustrative suitable nonionic surfactants are those disclosed in U.S. Pat. Nos. 4,316,812 and 3,630,929.

Nonionic surfactant, when present in the composition may be present in the amount of from about 0.01% to about 70%, specifically from about 0.2% to about 40%, more specifically from about 5% to about 20%, by weight of the composition.

Preferred nonionic surfactants include highly alkoxylated alcohol alkoxylates such as those having a degree of alkoxylation of from 20 to 80, preferably from 20 to 50 or 25 to 45. Preferred are alcohol ethoxylates or propoxylates, most preferably ethoxylates, such as C12-18 (EO)₂₀₋₈₀ Other preferred nonionic surfactants include secondary alcohol-based detersive surfactant having the formula:

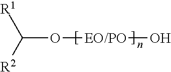

wherein R¹=linear or branched, substituted or unsubstituted, saturated or unsaturated C₂₋₈ alkyl; wherein R²=linear or branched, substituted or unsubstituted, saturated or unsaturated C₂₋₈ alkyl, wherein the total number of carbon atoms present in R¹+R² moieties is in the range of from 7 to 13; wherein EO/PO are alkoxy moieties selected from ethoxy, propoxy, or mixtures thereof; wherein n is the average degree of alkoxylation and is in the range of from 4 to 10.

In a further aspect of the invention, use of these highly alkoxylated alcohol or secondary alcohol based detersive surfactants in amounts of from 0.001 to 30 wt %, or 0.01 to 25 wt % or even 0.5 to 15 wt % of the composition enables the formation of highly stable compositions even at relatively high levels of anionic surfactant relative to nonionic surfactant (see ratios below), for anionic surfactants both amine neutralised or in acid or other salt form.

### Ratio of Anionic Surfactant to Nonionic Surfactant

In one embodiment, the compositions and methods of the present invention may have a weight ratio of the anionic surfactant to the nonionic surfactant from 1:1 to 5:1, more specifically greater than 2:1 to 5:1. The surfactant preferably comprises from 10% to 50%, more specifically from about 20% to about 40%, by weight of the composition, of anionic surfactant. The compositions of the invention preferably comprise from 5% to 40%, more specifically from 10% to 30%, by weight of the composition, of soap.

### Soap

Soap as defined herein includes fatty acids and soluble salts thereof. Fatty acids and/or soaps or their derivatives are known to possess multiple functionalities in detergents, acting as surfactants, builders, thickeners, foam suppressors etc. Therefore, for avoidance of doubt, for formula accounting purposes and in preferred embodiments herein, soaps and fatty acids are listed separately.

The soap may have any suitable cation as counterion. Mixtures of cations are also possible. Illustrative examples of suitable cations for the soap include, sodium, potassium, ammonium, substituted ammonium, amino functional cations, such as alkanolammonium and the like, and the like and mixtures thereof. In one embodiment, the soap is free of non-alkanolfunctionalised amines such as monoammonium and diammonium cations.

Any soluble soap or fatty acid is suitable for use herein, including, lauric, myristic, palmitic stearic, oleic, linoleic, linolenic acid, and mixtures thereof. Naturally obtainable fatty acids, which are usually complex mixtures, are also suitable (such as tallow, coconut, and palm kernel fatty acids). In one embodiment, from about 10% to about 25%, by weight of the composition, of fatty acid may be present in the composition.

In one embodiment, the soap has a degree of neutralization of greater than about 50%.

In another embodiment, the surfactant comprises from about 0% to less than about 40%, or even from 0 to 10% by weight of the composition, of soap.

Cationic and/or Amine Oxide and/or Zwitterionic and/or Amphoteric Surfactants

Suitable cationic surfactants are described in Surfactant Science Series, Vol. 67, Ed. Kuo Yann Lai, published by Marcel Dekker, NY, and in US 2003/0199414 A1 at Col. 9 H35141371. Suitable levels of cationic surfactant, when present in the compositions are from about 0.01% to about 20%, specifically from about 1% to about 10%, more specifically from about 2% to about 5%, by weight of the composition. Alternatively amine oxide surfactants such as the C8-C18 alkyldimethylamine-N-oxides, C8-C18 zwitterionic surfactants, C8-C18 amphoteric surfactants and/or C8-C18 alkylamidopropylamine surfactants (APA) may be used at similar levels. Mixtures of such surfactants can also be used.

The surfactants are typically present at a level of from 0.1% to 70% or 60% by weight or from 0.5 to 50 wt % or 1 to 40 wt % of the composition.

Hueing Dye—The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in EP1794275 or EP1794276, or dyes as disclosed in U.S. Pat. No. 7,208,459 B2, and mixtures thereof. In another aspect, suitable small molecule dyes include small molecule dyes selected from the group consisting of Colour Index numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, WO2011/47987, US2012/090102, WO2010/145887, WO2006/055787 and WO2010/142503. In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Preferred hueing dyes include the whitening agents found in WO 08/87497 A1, WO2011/011799 and WO2012/054835. Preferred hueing agents for use in the present invention may be the preferred dyes disclosed in these references, including those selected from Examples 1-42 in Table 5 of WO2011/011799. Other preferred dyes are disclosed in U.S. Pat. No. 8,138,222.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof. Builders—The cleaning composition may further contain builders, such as builders based on carbonate, bicarbonate or silicates which may be Zeolites, such as Zeolite A, Zeolite MAP (Maximum Aluminium type P). Zeolites, useable in laundry preferably has the formula Na₁₂(AlO₂)₁₂(SiO₂)₁₂.27H₂O and the particle size is usually between 1-10 μm for zeolite A and 0.7-2 um for zeolite MAP. Other builders are Sodium metasilicate (Na₂SiO₃.nH₂O or Na₂Si₂O₅.n H₂O) strong alkaline and preferably used in dish wash. In preferred embodiments, the amount of a detergent builder may be above 5%, above 10%, above 20%, above 30%, above 40% or above 50%, and may be below 80%, 65%. In a dishwash detergent, the level of builder is typically 40-65%, particularly 50-65% or even 75-90%.

pH: According to one aspect of the invention, the detergent compositions may have a pH ranging from about 6 to about 8.4 or 10. In another aspect, the detergent composition may have a pH ranging from about 7 to about 9. In another aspect, the detergent composition may have a pH ranging from about 6 or 7.5 to about 8.5. In another aspect, the detergent composition may have a pH of about 8.

Chelating Agents—The consumer products herein may contain a chelating agent. Suitable chelating agents include copper, iron and/or manganese chelating agents and mixtures thereof. When a chelating agent is used, the subject consumer product may comprise from about 0.005% to about 15% or even from about 3.0% to about 10% chelating agent by weight of the subject consumer product. Suitable chelants include DTPA (Diethylene triamine pentaacetic acid), HEDP (Hydroxyethane diphosphonic acid), DTPMP (Diethylene triamine penta(methylene phosphonic acid)), 1,2-Dihydroxybenzene-3,5-disulfonic acid disodium salt hydrate, ethylenediamine, diethylene triamine, ethylenediaminedisuccinic acid (EDDS), N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof.

Builders—The compositions of the present invention can comprise one or more detergent builders or builder systems. When present, the compositions will typically comprise at least about 1% builder, or from about 5% or 10% to about 80%, 50%, or 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds, ether hydroxy-polycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Polymers—The compositions of the invention may comprise one or more polymers. Examples are carboxymethylcellulose, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers and amphiphilic polymers.

### Amphiphilic Cleaning Polymers

Preferably, the amphiphilic cleanimg polymer is a compound having the following general structure: bis((C₂H_{S}O)(C₂H₄O)n)(CH₃)—N⁺—CₓH₂ₓ—N⁺—(CH₃)-bis((C₂H_{S}O)(C₂H₄O)n), wherein n=from 20 to 30, and x=from 3 to 8, or sulphated or sulphonated variants thereof.

Amphiphilic alkoxylated grease cleaning polymers of the present invention refer to any alkoxylated polymer having balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure. These may comprise alkoxylated polyalkylenimines, preferably having an inner polyethylene oxide block and an outer polypropylene oxide block.

The core structure may comprise a polyalkylenimine structure comprising, in condensed form, repeating units of formulae (I), (II), (III) and (IV):

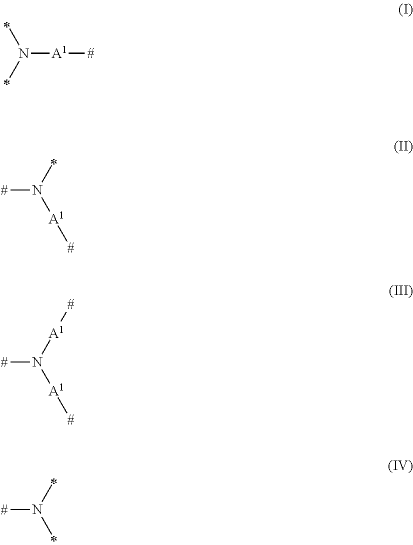

wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol.

The core structure may alternatively comprise a polyalkanolamine structure of the condensation products of at least one compound selected from N-(hydroxyalkyl)amines of formulae (I.a) and/or (I.b),

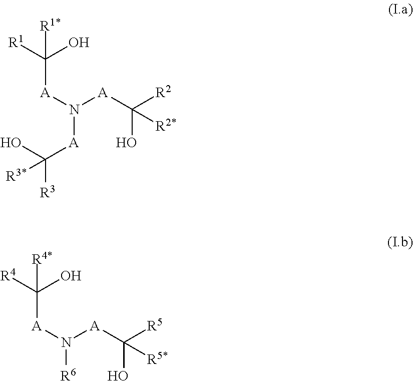

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted.

The plurality of alkylenoxy groups attached to the core structure are independently selected from alkylenoxy units of the formula (V)

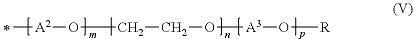

wherein * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 20 to about 50; and p has an average value in the range of from about 10 to about 50.

Specific embodiments of the amphiphilic alkoxylated grease cleaning polymers may be selected from alkoxylated polyalkylenimines having an inner polyethylene oxide block and an outer polypropylene oxide block, the degree of ethoxylation and the degree of propoxylation not going above or below specific limiting values. Specific embodiments of the alkoxylated polyalkylenimines according to the present invention have a minimum ratio of polyethylene blocks to polypropylene blocks (n/p) of about 0.6 and a maximum of about 1.5(x+2y+1)^{1/2}. Alkoxykated polyalkyenimines having an n/p ratio of from about 0.8 to about 1.2(x+2y+1)^{1/2} have been found to have especially beneficial properties.

The alkoxylated polyalkylenimines according to the present invention have a backbone which consists of primary, secondary and tertiary amine nitrogen atoms which are attached to one another by alkylene radicals A and are randomly arranged. Primary amino moieties which start or terminate the main chain and the side chains of the polyalkylenimine backbone and whose remaining hydrogen atoms are subsequently replaced by alkylenoxy units are referred to as repeating units of formulae (I) or (IV), respectively. Secondary amino moieties whose remaining hydrogen atom is subsequently replaced by alkylenoxy units are referred to as repeating units of formula (II). Tertiary amino moieties which branch the main chain and the side chains are referred to as repeating units of formula (III).

Since cyclization can occur in the formation of the polyalkylenimine backbone, it is also possible for cyclic amino moieties to be present to a small extent in the backbone. Such polyalkylenimines containing cyclic amino moieties are of course alkoxylated in the same way as those consisting of the noncyclic primary and secondary amino moieties.

The polyalkylenimine backbone consisting of the nitrogen atoms and the groups A¹, has an average molecular weight Mw of from about 60 to about 10,000 g/mole, preferably from about 100 to about 8,000 g/mole and more preferably from about 500 to about 6,000 g/mole.

The sum (x+2y+1) corresponds to the total number of alkylenimine units present in one individual polyalkylenimine backbone and thus is directly related to the molecular weight of the polyalkylenimine backbone. The values given in the specification however relate to the number average of all polyalkylenimines present in the mixture. The sum (x+2y+2) corresponds to the total number amino groups present in one individual polyalkylenimine backbone.

The radicals A¹ connecting the amino nitrogen atoms may be identical or different, linear or branched C₂-C₆-alkylene radicals, such as 1,2-ethylene, 1,2-propylene, 1,2-butylene, 1,2-isobutylene, 1,2-pentanediyl, 1,2-hexanediyl or hexamethylen. A preferred branched alkylene is 1,2-propylene. Preferred linear alkylene are ethylene and hexamethylene. A more preferred alkylene is 1,2-ethylene.

The hydrogen atoms of the primary and secondary amino groups of the polyalkylenimine backbone are replaced by alkylenoxy units of the formula (V).

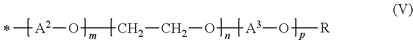

In this formula, the variables preferably have one of the meanings given below:

A² in each case is selected from 1,2-propylene, 1,2-butylene and 1,2-isobutylene; preferably A² is 1,2-propylene. A³ is 1,2-propylene; R in each case is selected from hydrogen and C₁-C₄-alkyl, such as methyl, ethyl, n-propyl, isopropyl, n-butyl, isobutyl and tert.-butyl; preferably R is hydrogen. The index m in each case has a value of 0 to about 2; preferably m is 0 or approximately 1; more preferably m is 0. The index n has an average value in the range of from about 20 to about 50, preferably in the range of from about 22 to about 40, and more preferably in the range of from about 24 to about 30. The index p has an average value in the range of from about 10 to about 50, preferably in the range of from about 11 to about 40, and more preferably in the range of from about 12 to about 30.

Preferably the alkylenoxy unit of formula (V) is a non-random sequence of alkoxylate blocks. By non-random sequence it is meant that the [-A²-O-]ₘ is added first (i.e., closest to the bond to the nitrogen atom of the repeating unit of formula (I), (II), or (III)), the [—CH₂—CH₂—O—]ₙ is added second, and the [-A³-O-]ₚ is added third. This orientation provides the alkoxylated polyalkylenimine with an inner polyethylene oxide block and an outer polypropylene oxide block.

The substantial part of these alkylenoxy units of formula (V) is formed by the ethylenoxy units —[CH₂—CH₂—O]ₙ— and the propylenoxy units —[CH₂—CH₂(CH₃)—O]ₚ—. The alkylenoxy units may additionally also have a small proportion of propylenoxy or butylenoxy units -[A²-O]ₘ—, i.e. the polyalkylenimine backbone saturated with hydrogen atoms may be reacted initially with small amounts of up to about 2 mol, especially from about 0.5 to about 1.5 mol, in particular from about 0.8 to about 1.2 mol, of propylene oxide or butylene oxide per mole of NH— moieties present, i.e. incipiently alkoxylated.

This initial modification of the polyalkylenimine backbone allows, if necessary, the viscosity of the reaction mixture in the alkoxylation to be lowered. However, the modification generally does not influence the performance properties of the alkoxylated polyalkylenimine and therefore does not constitute a preferred measure.

The amphiphilic alkoxylated grease cleaning polymers are present in the fabric and home care products, including but not limited to detergents, of the present invention at levels ranging from about 0.05% to 10% by weight of the fabric and home care product. Embodiments of the fabric and home care products may comprise from about 0.1% to about 5% by weight. More specifically, the embodiments may comprise from about 0.25 to about 2.5% of the grease cleaning polymer.

Carboxylate polymer—The consumer products of the present invention may also include one or more carboxylate polymers such as a maleate/acrylate random copolymer or polyacrylate homopolymer. In one aspect, the carboxylate polymer is a polyacrylate homopolymer having a molecular weight of from 4,000 Da to 9,000 Da, or from 6,000 Da to 9,000 Da.

Soil release polymer—The consumer products of the present invention may also include one or more soil release polymers having a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

Cellulosic polymer—The consumer products of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da.

Suds modifiers—The compositions of the present invention may include one or more suds modifiers. Suds modifiers are described in U.S. Pat. Nos. 3,933,672 and 4,136,045.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Pearlescent Agent—In some aspects of the present invention, the laundry detergent compositions further comprise a pearlescent agent. Pearlescent agents of use include those described in USPN 2008/0234165A1. Non-limiting examples of pearlescent agents may be selected from the group of: mica; titanium dioxide coated mica; bismuth oxychloride; fish scales; mono and diesters of alkylene glycol of the formula:

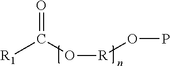

wherein:
a. R₁ is linear or branched C12-C22 alkyl group;
b. R is linear or branched C2-C4 alkylene group;
c. P is selected from the group of: H; C1-C4 alkyl; or —COR₂; and
d. n=1-3.

In some embodiments, R2 is equal to R1, such that the alkylene glycol is ethyleneglycoldistearate (EGDS).

The composition may comprise an encapsulate, in particular, an encapsulate comprising a core, a shell having an inner and outer surface, said shell encapsulating said core.

In such encapsulates, said core may comprise a material selected from the group consisting of perfumes; brighteners; dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

In a preferred encapsulate, the core comprises perfume.

In a preferred encapsulate, the shell may comprise melamine formaldehyde and/or cross linked melamine formaldehyde.

In one aspect of the invention suitable encapsulates for incorporation into the compositions of the invention may comprise a core material and a shell, said shell at least partially surrounding said core material, is disclosed. At least 75%, 85% or even 90% of said encapsulates may have a fracture strength of from about 0.2 MPa to about 10 MPa, from about 0.4 MPa to about 5 MPa, from about 0.6 MPa to about 3.5 MPa, or even from about 0.7 MPa to about 3 MPa; and a benefit agent leakage of from 0% to about 30%, from 0% to about 20%, or even from 0% to about 5%. In one aspect, at least 75%, 85% or even 90% of said encapsulates may have a particle size of from about 1 microns to about 80 microns, about 5 microns to 60 microns, from about 10 microns to about 50 microns, or even from about 15 microns to about 40 microns. In one aspect, at least 75%, 85% or even 90% of said encapsulates may have a particle wall thickness of from about 30 nm to about 250 nm, from about 80 nm to about 180 nm, or even from about 100 nm to about 160 nm.

In one aspect, said encapsulates' core material may comprise a material selected from the group consisting of a perfume raw material and/or optionally a material selected from the group consisting of vegetable oil, including neat and/or blended vegetable oils including caster oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof; aromatic solvents, including benzene, toluene and mixtures thereof; silicone oils; and mixtures thereof.

In one aspect, said encapsulates' wall material may comprise a suitable resin including the reaction product of an aldehyde and an amine, suitable aldehydes include, formaldehyde. Suitable amines include melamine, urea, benzoguanamine, glycoluril, and mixtures thereof. Suitable melamines include methylol melamine, methylated methylol melamine, imino melamine and mixtures thereof. Suitable ureas include, dimethylol urea, methylated dimethylol urea, urea-resorcinol, and mixtures thereof.

In one aspect, suitable formaldehyde scavengers may be employed with the encapsulates, for example, in a capsule slurry and/or added to a consumer product before, during or after the encapsulates are added to such consumer product.

Suitable capsules that can be made by following the teaching of USPA 2008/0305982 A1; and/or USPA 2009/0247449 A1. Alternatively, suitable capsules can be purchased from Appleton Papers Inc. of Appleton, Wis. USA.

In addition, the materials for making the aforementioned encapsulates can be obtained from Solutia Inc. (St Louis, Mo. U.S.A.), Cytec Industries (West Paterson, N.J. U.S.A.), sigma-Aldrich (St. Louis, Mo. U.S.A.), CP Kelco Corp. of San Diego, Calif., USA; BASF AG of Ludwigshafen, Germany; Rhodia Corp. of Cranbury, N.J., USA; Hercules Corp. of Wilmington, Del., USA; Agrium Inc. of Calgary, Alberta, Canada, ISP of New Jersey U.S.A., Akzo Nobel of Chicago, Ill., USA; Stroever Shellac Bremen of Bremen, Germany; Dow Chemical Company of Midland, Mich., USA; Bayer AG of Leverkusen, Germany; Sigma-Aldrich Corp., St. Louis, Mo., USA.

In one aspect, the composition may comprise an enzyme stabilizer/inhibitor selected from the group consisting of (a) inorganic salts selected from the group consisting of calcium salts, magnesium salts and mixtures thereof; (b) carbohydrates selected from the group consisting of oligosaccharides, polysaccharides and mixtures thereof; and (c) mixtures thereof. In another embodiment, the composition comprises additional protease stabilizer: (1) 1-2 propane diol; (2) diethylene glycol; (3) inorganic salts selected from the group consisting calcium salts, magnesium salts and mixtures thereof; (4) carbohydrates selected from the group consisting of oligosaccharides, polysaccharides and mixtures thereof; (5) any combination thereof. Preferred are (1) 1-2 propane diol; (2) calcium salts such as calcium formate or calcium chloride, and/or sodium formate; and (3) any combination thereof.

In a preferred aspect of the invention, the composition comprises a weight ratio of neutralised anionic surfactant:calcium ion of from 200:1 to 20,000:1, preferably from 1000:1 to 2500:1. In a further aspect of the invention, the compositions of the invention preferably comprise a calcium ion:phenylboronic acid weight ratio of from 0.02:1 to 5:1, preferably from 0.03:1 to 1.6:1. In a further aspect of the invention, preferably the weight ratio of calcium ion:serine protease in the composition is from 0.1:1 to 20:1, preferably from 0.2:1 to 10:1. In a further preferred aspect of the invention the compositions comprise from 0.001 to 0.2%, preferably from 0.001 to 0.1%, or from 0.002 to 0.05% salts of calcium.

In a further preferred embodiment of the invention the ionic strength of the composition is such that a solution of 10 g/l of the composition in distilled water has an ionic strength of less than 0.05, preferably less than 0.007 or 0.001. Ionic strength, I of an aqueous solution is defined as I=0.5*Σ(mⱼ/(1 mol L⁻¹))zⱼ² where mⱼ is the molarity in mol L⁻¹ of ionic species j, and zⱼ is the amount of charge on the ion irrespective of whether it is positive or negative. For example for Na⁺ and Cl−zj=1, for Mg2+zj=2. Ionic species include charged surfactants, charged ionic species and inorganic ions.

In a further preferred aspect of the invention, the compositions comprise no greater than 20%, or no greater than 15%, or no greater than 10%, or no greater than 5%, or no greater than 3% of a solvent selected from the group consisting of 1,2 propane diol and ethanol and mixtures thereof, more preferably the compositions of the invention comprise no greater than these amounts of a solvent selected from the group consisting of 1,2 propane diol, ethanol, diethylene glycol and mixtures thereof. The compositions may be free of these solvents or may comprise from 0.05 or even 0.1 wt %.

In one aspect, the composition may comprise a structurant selected from the group consisting of diglycerides and triglycerides, ethylene glycol distearate, microcrystalline cellulose, cellulose-based materials, microfiber cellulose, biopolymers, xanthan gum, gellan gum, hydrogenated castor oil, and mixtures thereof.

The detergent may comprise one or more polymers. Examples are carboxymethylcellulose, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The detergent may contain a bleaching system, which may comprise a H₂O₂ source such as perborate or percarbonate which may be combined with a peracid-forming bleach activator such as tetraacetylethylenediamine or nonanoyloxybenzenesulfonate. Alternatively, the bleaching system may comprise peroxyacids of, e.g., the amide, imide, or sulfone type.

In general, when a bleaching agent is used, the compositions of the present invention may comprise from about 0.1% to about 50% or even from about 0.1% to about 25% bleaching agent by weight of the subject cleaning composition.

Where the compositions of the invention are substantially non-aqueous, they may comprise from 2% to 40%, more preferably from 5% to 25% by weight of a non-aqueous solvent. As used herein, “non-aqueous solvent” refers to any organic solvent which contains no amino functional groups. Preferred non-aqueous solvents include monohydric alcohols, dihydric alcohols, polyhydric alcohols, glycerol, glycols including polyalkylene glycols such as polyethylene glycol, and mixtures thereof. More preferred non-aqueous solvents include monohydric alcohols, dihydric alcohols, polyhydric alcohols, glycerol, and mixtures thereof. Highly preferred are mixtures of solvents, especially mixtures of two or more of the following: lower aliphatic alcohols such as ethanol, propanol, butanol, isopropanol; diols such as 1,2-propanediol or 1,3-propanediol; and glycerol. Also preferred are propanediol and mixtures thereof with diethylene glycol where the mixture contains no methanol or ethanol. Thus embodiments of non-aqueous liquid compositions of the present invention may include embodiments in which propanediols are used but methanol and ethanol are not used.

Preferable non-aqueous solvents are liquid at ambient temperature and pressure (i.e. 21° C. and 1 atmosphere), and comprise carbon, hydrogen and oxygen. Non-aqueous solvents may be present when preparing a premix, or in the final non-aqueous composition.

The liquid detergent compositions herein may take the form of an aqueous solution or uniform dispersion or suspension of surfactant, dual character polymer, and certain optional adjunct ingredients, some of which may normally be in solid form, that have been combined with the normally liquid components of the composition, such as the liquid alcohol ethoxylate nonionic, the aqueous liquid carrier, and any other normally liquid optional ingredients. Such a solution, dispersion or suspension will be acceptably phase stable and will typically have a viscosity which ranges from about 100 to 600 cps, or from about 150 to 400 cps. For purposes of this disclosure, viscosity is measured with a Brookfield LVDV-II+viscometer apparatus using a #21 spindle.

The detergent could contain a pre-spotter or a booster, which is added to the wash to increase the general cleaning level, some of these additives may also be used as a pre-treatment agent applied to the textile before the washing step.

The detergent composition of the invention may be in any fluid form, e.g. a paste, a gel or a liquid. The composition may also be in unit dose packages, such as a pouch, including multi-compartment pouches, including those known in the art and those that are water soluble, water insoluble and/or water permeable.

The composition of the invention may for example be formulated as a hand or machine laundry detergent composition including a laundry additive composition suitable for pre-treatment of stained fabrics or be formulated as a detergent composition for use in general household hard surface cleaning operations, or be formulated for hand or machine dishwashing operations

### Processes of Making Detergent Compositions

In accordance with the present invention there is also provided a method for making a liquid detergent composition as described above comprising the following steps:
(i) reacting an acid precursor of an anionic surfactant with an amine to produce a neutralized anionic surfactant;
(ii) mixing the neutralized anionic surfactant with a protease enzyme;
(iii) mixing the neutralized anionic surfactant with a protease-sensitive component; and
(iv) mixing the amine-neutralised surfactant with phenyl boronic acid or phenyl boronic acid derivative free of reactive aldehyde substituent;
(v) mixing the amine-neutralised surfactant with an adjunct ingredient selected from the group consisting of (a) additional enzyme stabilizers selected from the group consisting of calcium formate or calcium chloride, 1,2 propanediol, diethylene glycol, lactic acid and derivatives thereof, (b) chelating agent, (c) structurant or mixtures thereof, preferably selected from calcium chloride, calcium formate and/or diethylene glycol;
   wherein steps (i), (ii), (iii), (iv) and (v) may be simultaneous or sequential in any order, with the proviso that step (iv) must be simultaneous with or prior to at least one of steps (ii) or (iii).

By simultaneous, it is intended to mean that the steps may be at the same time or that the separate components may be added to one another without a substantial time delay between addition of the respective components, for example in a batch process. A substantial time delay would be for example more than 30 minutes, or more than 15 minutes or more than 10 or more than 5 minutes.

In a preferred process according to the invention, the phenyl boronic acid derivative is mixed with the amine-neutralised anionic surfactant, followed by simultaneous or sequential steps b and/or c and optional mixing of additional adjunct ingredients. In a further preferred embodiment the phenyl boronic acid or derivative is mixed with the serine-protease enzyme, the mixture of serine-protease enzyme and phenyl boronic acid or derivative subsequently being mixed with the amine-neutralised anionic surfactant.

The detergent compositions of the present invention can be formulated based on the processes described in U.S. Pat. Nos. 5,879,584; 5,691,297; 5,574,005; 5,569,645; 5,565,422; 5,516,448; 5,489,392; and 5,486,303. In one aspect, the detergent compositions disclosed herein may be prepared by combining the components thereof in any convenient order and by mixing, e.g., agitating, the resulting component combination to form a phase stable liquid detergent composition. In one aspect, a liquid matrix is formed containing at least a major proportion, or even substantially all, of the liquid components, e.g., anionic surfactant, nonionic surfactant, the non-surface active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of the solid ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills, are incorporated. As a variation of the composition preparation procedure described above, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

### Methods of Using Detergent Compositions

The detergent compositions of the present disclosure may be used to clean, treat, or pretreat a textile surface. Typically at least a portion of the fabric is contacted with the aforementioned detergent compositions, in neat form or diluted in a liquor, e.g., a wash liquor, and then the fabric may be optionally washed and/or rinsed. In one aspect, a fabric is optionally washed and/or rinsed, contacted with the aforementioned detergent compositions and then optionally washed and/or rinsed. For purposes of the present invention, washing includes but is not limited to, scrubbing, and mechanical agitation. Typically after washing and/or rinsing, the fabric is dried. The fabric may comprise most any fabric capable of being laundered or treated.

The detergent compositions of the present disclosure may be used to form aqueous washing solutions for use in the laundering of fabrics. Generally, an effective amount of such compositions is added to water, for example in a conventional fabric laundering automatic washing machine or by a hand washing method, to form such aqueous laundering solutions. The aqueous washing solution so formed is then contacted, preferably under agitation, with the fabrics to be laundered therewith. An effective amount of the detergent composition, such as the of the present disclosure, may be added to water to form aqueous laundering solutions that may comprise from about 200 to about 15,000 ppm or even from about 300 to about 7,000 pm of detergent composition.

### Enzyme Stability Test Data

Test of stability of Protease in an Amine Neutralized-Anionic Surfactant-Containing Detergent after Incubation in Detergent, Example 10, at pH 8.2

### Method:

A detergent composition, example 10, nil enzyme, nil calcium chloride dihydrate and nil phenylboronic acid (PBA), balanced to pH 8.2 using monoethanolamine, was prepared.

The protease, that sold under the trade name of Purafect Prime®, by Genencor International, Palo Alto (38.7 mg active Protease protein in 100 g detergent), was added to the above detergent. Each detergent sample was determined for the initial residual enzyme activity before incubation (Initial reference samples).

TABLE 1

| | Detergent Description |
|---|---|
| A. Test Reference 1 | Detergent example 10 + Protease + Ca chloride |
| | 0.04%, nil PBA |
| B. Test Leg 1 | Detergent example 10 + Protease + Ca chloride |
| | 0.04%, PBA 0.04% active |
| C. Test Reference 2 | Detergent example 10 + Protease + Ca chloride |
| | 0.06%, nil PBA |
| D. Test Leg 2 | Detergent example 10 + Protease + Ca chloride |
| | 0.06%, PBA 0.04% active |

### Experimental Results

The residual enzyme activity for each sample was determined after incubation at 30° C. for 3 weeks and 6 weeks and compared to their reference sample. The residual activity was determined using the standard enzyme activity assays for the relevant enzyme.

### Procedure:

Detergent formulations A-D, 5 g pH 8.2, were placed in duplicate into a 7 ml glass vial with an air tight lid. The residual enzyme activity was determined for the initial samples, in duplicate, before incubation.

The samples were placed into an incubator for 3 weeks and 6 weeks at 30° C. Immediately after incubation, the samples were analysed for both residual Protease. In this test the residual activity of 100% equals no loss of Protease activity compared to initial residual enzyme activity before incubation.

TABLE 2
Results

| | |
|---|---|
| Residual activity (%) | Protease |

| pH 8.2, 30° C. | 3 Weeks | 6 Weeks |
|---|---|---|
| A. Nil PBA + Ca chloride 0.04% | 67 | 53 |
| B. PBA 0.04% + Ca chloride 0.04% | 79 | 69 |
| C. Nil PBA + Ca chloride 0.06% | 80 | 68 |
| D. PBA 0.04% + Ca chloride 0.06% | 88 | 81 |

The results show that the addition of PBA to Detergent example 10 of the invention, significantly improves stability of the Protease at pH 8.2, 3 weeks and 6 weeks 30° C. versus a nil PBA reference.

### Examples 1-10

### Heavy Duty Liquid Laundry Detergent Compositions

| | Detergent Composition wt % | | | | | | | | | |
|---|---|---|---|---|---|---|---|---|---|---|
| | 1 | 2 | 3 | 4 | 5 | 6 | 7 | 8 | 9 | 10 |
| C₁₂₋₁₈ Alkylethoxy (1.8-5) | 14.7 | 11.6 | | 16.31 | | 17.29 | | 17.29 | | |
| sulfate | | | | | | | | | | |
| C₁₂ Alkylbenzene sulfonate: | 4.3 | 11.6 | 8.3 | 7.73 | 11.7 | 7.73 | 10.19 | 7.74 | 11.35 | 8.35 |
| monoethanol amine neutralised | | | | | | | | | | |
| C₁₂₋₁₈ Branched alkyl sulfate | 1.7 | 1.29 | | 3.09 | | 3.3 | | 3.3 | | |
| C₁₂₋₁₈ Dimethylamine oxide | 0.6 | 0.64 | | 1.03 | | 1.03 | 0.37 | 1.03 | | |
| Citric acid | 3.5 | 0.65 | 3 | 0.66 | 2.27 | 0.67 | 3.14 | 0.67 | 2.84 | 2.84 |
| C₁₂₋₁₈ fatty acid | 1.5 | 2.32 | 3.6 | 1.52 | 0.82 | 1.52 | 2.59 | 1.52 | 5.54 | 9.46 |
| Phenyl Boronic Acid | 0.02 | 0.01 | 0.01 | 0.01 | | 0.02 | 0.02 | 0.04 | 0.04 | 0.04 |
| Sodium C₁₂₋₁₈ alkyl ethoxy | | | 2.9 | | 3.9 | | | | 12.5 | 8.51 |
| (3-9) sulfate | | | | | | | | | | |
| C₁₂₋₁₈ Alkyl (7-9) ethoxylate | 0.9 | 1.07 | 5.9 | 1.31 | 2.4 | 1.3 | 7.4 | 1.3 | 7.6 | 7.6 |
| CaCl₂•2H₂O | | | | | 0.045 | | 0.046 | | 0.04 | 0.06 |
| Calcium formate | 0.09 | 0.09 | | 0.09 | | 0.09 | | 0.09 | | |
| bis((C₂H₅O)(C₂H₄O)n)(CH₃)— | | | 1.2 | | 0.66 | | 0.63 | | 2.08 | 2.08 |
| N⁺—CₓH₂ₓ—N⁺—(CH₃)- | | | | | | | | | | |
| bis((C₂H₅O)(C₂H₄O)n) n = 20-30; | | | | | | | | | | |
| x = 3-8 (optionally sulphated | | | | | | | | | | |
| or sulphonated) | | | | | | | | | | |
| Polymer¹ | | 1.46 | 0.5 | | 0.83 | | 0.80 | | 0.85 | 0.85 |
| Ethoxylated Polyethylenimine² | 1.5 | 1.29 | | 1.44 | | 1.44 | | 1.44 | | |
| DTPA⁶ | 0.34 | 0.64 | | 0.34 | | 0.34 | | 0.34 | | |
| DTPMP⁷ | | | 0.3 | | 0.3 | | 0.41 | | 1.3 | |
| HEDP⁸ | | | | | 0.18 | | | | | 1.51 |
| Dihydroxybenzene-3,5- | | | | | | 0.19 | | 0.19 | | |
| disulfonic acid disodium | | | | | | | | | | |
| salt hydrate | | | | | | | | | | |
| Tinopal_{AMS-GX} | | 0.06 | | | | 0.29 | | | | |
| Tinopal_{CBS-X} | 0.2 | 0.17 | | 0.29 | | | | 0.29 | | 0.22 |
| Tinopal_{TAS-XB36} | | | | | 0.091 | | 0.087 | | 0.31 | |
| Amphiphilic | 1.28 | 1 | 0.4 | 1.93 | | 1.93 | | 1.93 | | |
| alkoxylated polymer³ | | | | | | | | | | |
| Ethanol | 2 | 1.58 | 1.6 | 5.4 | 1.2 | 3.57 | 1.15 | 2.19 | | |
| Propylene Glycol | 3.9 | 3.59 | 1.3 | 4.3 | | 3.8 | 3.96 | 3.8 | 8.0 | 6.0 |
| Diethylene glycol | 1.05 | 1.54 | | 1.15 | | 1.15 | | 1.15 | 2.8 | 4.0 |
| Polyethylene glycol | 0.06 | 0.04 | | 0.1 | | 0.1 | | | | |
| ⁴Protease (Purafect Prime ®, | 1.11 | 1.5 | 0.39 | 0.8 | 0.39 | 1.0 | 0.39 | 1.11 | 0.71 | 0.71 |
| 54.5 mg active/g) | | | | | | | | | | |
| ⁵Mannanase (Mannaway ®, | 0.6 | 0.4 | 0.2 | 0.3 | 0.1 | 0.05 | 0.39 | | 0.17 | 0.17 |
| 25 mg/g active) | | | | | | | | | | |
| Monoethanol amine | 3.05 | 2.41 | 0.4 | 1.26 | 0.31 | 1.13 | 0.30 | 1.13 | 8.27 | 10.84 |
| NaOH | 2.44 | 1.8 | | 3.01 | 3.84 | 0.24 | | | | |
| Sodium Cumene Sulphonate | | | 1 | | 0.95 | | 0.93 | | | |
| Sodium Formate | | 0.11 | | 0.09 | 0.2 | 0.12 | 0.2 | 0.12 | 0.12 | 0.38 |

| | |
|---|---|
| Water, Aesthetics (Dyes, | balance |
| perfumes) and Minors | |
| (Enzymes, solvents, | |
| structurants) | |

¹Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
²Polyethylenimine (MW = 600) with 20 ethoxylate groups per —NH.
³Amphiphilic alkoxylated grease cleaning polymer is a polyethylenimine (MW = 600) with 24 ethoxylate groups per —NH and 16 propoxylate groups per —NH.
⁴Purafect Prime ® is a product of Genencor International, Palo Alto, California, USA.⁵
⁵Mannaway ® is a product of Novozymes, Bagsvaerd, Denmark.
⁶DTPA is_Diethylene triamine pentaacetic acid
⁷DTPMP is Diethylene triamine penta (methylene phosphonic acid)
⁸HEDP is 1-hydroxyethyidene-1,1-diphosphonic acid

### Examples 11

### Heavy Duty Liquid Laundry Detergent Composition

| | 11 |
|---|---|
| | (wt %) |
| Alkylbenzene sulfonate: monoehanolamine neutralised | 21.0 |
| C₁₄₋₁₅ alkyl 8-ethoxylate | 18.0 |
| C₁₂₋₁₈ Fatty acid | 15.0 |
| ²Protease (Purafect Prime ®, 40.6 mg active/g) | 1.5 |
| ³Mannanase (Mannaway ®, 11 mg active/g) | 0.1 |
| ³Xyloglucanase (Whitezyme ®, 20 mg active/g) | 0.2 |
| ³Amylase (Natalase ®, 29.26 mg active/g) | 5.9 |
| Phenyl boronic acid | 0.02 |
| bis((C₂H₅O)(C₂H₄O)n)(CH₃)—N⁺—CₓH₂ₓ—N⁺—(CH₃)- | 2.0 |
| bis((C₂H₅O)(C₂H₄O)n), n = 20-30; x = 3-8 | |
| (optionally sulphated or sulphonated) | |
| Ethoxylated Polyethylenimine¹ | 0.8 |
| Hydroxyethane diphosphonate (HEDP) | 0.8 |
| Fluorescent Brightener⁴ | 0.2 |
| Solvents (1,2 propanediol, ethanol), stabilizers | 15.0 |
| Hydrogenated castor oil derivative | 0.1 |
| Perfume | 1.6 |
| Melamine-formaldehyde encapsulate of perfume | 0.10 |
| (perfume microcapsules) | |
| Ethoxylated thiophene Hueing Dye | 0.004 |
| Sodium hydroxide | To pH 8.2 |
| Water** and minors (antifoam, aesthetics) | To 100% |

**Based on total cleaning and/or treatment composition weight, a total of no more than 7% water.
¹Polyethyleneimine (MW = 600) with 20 ethoxylate groups per —NH.
²Purafect Prime ® is a product of Genencor International, Palo Alto, California, USA
³Natalase ®, Mannaway ® and Whitezyme ® are all products of Novozymes, Bagsvaerd, Denmark.
⁴Fluorescent Brightener can be anyone of Tinopal ® AMS-GX, Tinopal ® CBS-X or Tinopal ® TAS-X B36, or mixtures thereof, all supplied by Ciba Specialty Chemicals, Basel, Switzerland

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
(i) amine-neutralised anionic surfactant;
(ii) a serine protease enzyme;
(iii) protease sensitive-component;
(iv) phenyl boronic acid or phenyl boronic acid derivative free of reactive aldehyde substituents; and
(v) an adjunct ingredient selected from (a) additional enzyme stabilizers selected from the group consisting of calcium formate or calcium chloride, 1,2 propanediol, diethylene glycol, lactic acid and derivatives thereof, (b) chelating agent, (c) structurant or mixtures thereof.

2. A composition according to claim 1 comprising unsubstituted phenyl boronic acid.

3. A composition according to claim 1 wherein said adjunct ingredient (v) is selected from the group consisting of calcium formate, calcium chloride, 1,2 propanediol, diethylene glycol, lactic acid and derivatives thereof, and mixtures thereof.

4. A composition according to claim 1 wherein the adjunct ingredient is selected calcium chloride, calcium formate and diethylene glycol and mixtures thereof.

5. A composition according to claim 1 wherein the protease-sensitive component comprises an enzyme selected from the group consisting of hemicellulases, peroxidases, cellulases, cellobiose dehydrogenases, xyloglucanases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, lichenases glucanases, arabinosidases, hyaluronidase, chondroitinase, laccase, amylases, protease, particularly non-serine proteases or mixtures thereof.

6. A composition according to claim 5 wherein the protease-sensitive component comprises an enzyme selected from the group consisting of amylase, lipase and cellulase enzymes, mixtures thereof.

7. A composition according to claim 1 wherein the serine protease is selected from the group comprising of:
(i) the protease of SEQ ID NO:1;
(ii) the protease of SEQ ID NO:1 further comprising the substitutions Y167A+R170S+A194P (BPN' numbering system);
(iii) the protease of SEQ ID NO:2 comprising the substitution Y217L;
(iv) the protease of SEQ ID NO:2 comprising a total of three, four, five, six, seven, eight, nine, 10, 11, 12, 13, 14 or 15 mutations selected from groups (a) and (b) below:
(a) A1E/T, S9/T, P14L, A15L, L16C, H17T, S18L/T, Q19K, G20A, Y21N/T, T22L, G23E, S33T, K43Y, N76D, G102A, N109A/S/G, A137V, K141R, T158S, G169A, S204E, P210S, N218S, N243P/V, S248N/A, S249A, K256R, L257G, S260P, and N269D; and
(b) S24G/R/E, N25G, P40A/E, P52L, S53G, T55P, F58G, Q59S, N61E/P/G/S, N62Q/R/S, S63G/H, V68A, S78N, P86S, S87D/G, A88T/V, S89Y, A92G, L96T, G97A, G100N/Q/T, S101N, Q103E/H, Y104N, W106F, I111V, A114G, I115V, A116N/T, N117S, N118G, N123A/G/Q/V, M124I/V, S125A, L126A, G128A/S, P129E/Q/S/V, S130G, G131S/H, S132N, A133V, A134T, A144K, S145D, S159K, S161P, S162G/K, Y167A, P194L, V203Y, Q206D/E, K213L, Y217Q/L/D, V227T, A232T, P239R/V, N240K, T242R, K265N, L267V, and Q275E; and
(v) mixtures thereof.

8. A composition according to claim 1 wherein the protease-sensitive component is selected from the group consisting of:
(i) a first wash lipase;
(ii) a mannanase;
(iii) cellulase enzyme;
(iv) pectate lyase;
(v) an alpha-amylase;
(vi) mixtures thereof.

9. A composition according to claim 1 wherein the protease-sensitive component comprises an enzyme selected from the group consisting of mannanase, pectate lyase and mixtures thereof.

10. A composition according to claim 1 comprising one or more of the following:
(i) an anionic surfactant:calcium ion weight ratio of from 200 to 20,000:1;
(ii) a calcium ion:phenylboronic acid weight ratio of from 0.02 to 5:1,
(iii) a calcium ion:serine protease weight ratio of from 0.01 to 20:1.

11. A composition according to claim 10 wherein the calcium ion is provided to the composition in the form of calcium chloride and/or calcium formate.

12. A composition according to claim 1 comprising no greater than 10% by weight of a solvent selected from the group consisting of 1,2 propane diol and ethanol and mixtures thereof.

13. A composition according to claim 1 comprising from 0.001 to 0.2 wt % salts of calcium.

14. A composition according to claim 1 additionally having an ionic strength such that a solution of 10 g/l of the composition in distilled water has an ionic strength of less than 0.05.

15. A composition according to claim 1 in which the amine counterion of the anionic surfactant is selected from the group consisting mono-ethanolamine, di-ethanolamine and tri-ethanolamine.

16. A method for making a liquid detergent composition according to claim 1 comprising the following steps:
(i) reacting an acid precursor of an anionic surfactant with an amine to produce a neutralized anionic surfactant;
(ii) mixing the neutralized anionic surfactant with a protease enzyme;
(iii) mixing the neutralized anionic surfactant with a protease-sensitive component; and
(iv) mixing the amine-neutralised surfactant with phenyl boronic acid,
(v) mixing the amine-neutralised surfactant with an adjunct ingredient selected from an adjunct ingredient selected from (a) additional enzyme stabilizers selected from the group consisting of calcium formate or calcium chloride, 1,2 propanediol, diethylene glycol, lactic acid and derivatives thereof, (b) chelating agent, (c) structurant or mixtures thereof;
wherein steps (i) (ii), (iii), (iv) and (v) may be simultaneous or sequential in any order with the proviso that step (iv) must be simultaneous with or prior to at least one of steps (ii) or (iii).

17. A method according to claim 16 in which the neutralized anionic surfactant is mixed with a detergent adjunct prior to addition of the protease.

18. A method of treating and/or cleaning a textile, comprising (i) forming an aqueous wash liquor comprising water and a composition according to claim 1, (ii) treating the surface with the aqueous wash liquor at a temperature of 40° C. or less; and (iii) rinsing the surface.


SEQUENCE LISTING (7 sequences)

SEQ ID NO: 1 - protein, 269 aa, Bacillus Lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 275 aa, Bacillus Amyloliquefaciens [sequence omitted]

SEQ ID NO: 3 - protein, 269 aa, Thermomyces lanuginosus [sequence omitted]

SEQ ID NO: 4 - protein, 523 aa, Paenibacillus polymyxa
VVHGQTAKTITIKVDTFKDRKPISPYIYGTNQDLAGDENMAARRLGGNRMTGYNWENNMSNAGSDWQQSSDYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 5 - protein, 399 aa, Bacillus subtilisis DSM 14218 [sequence omitted]

SEQ ID NO: 6 - protein, 485 aa, Bacillus sp722
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 7 - protein, 485 aa, Bacillus AA560
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK